(19) United States
(12) Patent Application Publication
(10) Pub. No.: US 2008/0200620 A1
(43) Pub. Date: Aug. 21, 2008

(54) Spray Polyurea System, Process for Producing and Use Thereof

(75) Inventors: Marc Broekaert, Zottegram (BE); Stefan Priemen, Sint Truiden (BE); Joerg Volle, Selm-Bork (DE); Michael Vogel, Efringen-Kirchen (DE)

Correspondence Address: HUNTSMAN INTERNATIONAL LLC, LEGAL DEPARTMENT, 10003 WOODLOCH FOREST DRIVE, THE WOODLANDS, TX, 77380, US

(73) Assignees: Huntsman International LLC, Salt Lake City, UT (US); Huntsman Advanced Materials (Americans) Inc., The Woodslands, TX (US)

(21) Appl. No.: 11/994,697

(22) PCT Filed: Jun. 29, 2006
(86) PCT No.: PCT/EP2006/063676

§ 371 Date: Jan. 4, 2008

(30) Foreign Application Priority Data
Jul. 7, 2005 (EP) 0510614.6

(51) Int. Cl. C08L 75/02; C08G 18/28

(52) U.S. Cl. 525/457; 528/60

(57) ABSTRACT

Polyurea spray system containing a polyisocyanate, a polyamine and an imidazoline-containing polyaminoamide as chain extender, suitable for use as internal coating of drinking water pipelines and storage tanks.

This invention relates to a (hybrid) polyurea system and its use primarily in coating the internal surface of drinking water pipelines or storage tanks.

Polyurea elastomers have found widespread utility, including as coatings, such as for spray applications, and as foams.

When used as coatings, these materials provide a desirable balance of properties including: light stability; fast cure; relative water insensitivity; solventless systems; excellent physical properties, including tensile strength, elongation and abrasion resistance; pigmentation capability; ease of application, such as using commercially available spray application equipment; and, since no catalyst is needed, consistent reactivity and long term storage stability.

Polyureas are useful in a variety of foam applications including, among others: molded foams, such as in automobile interiors like seating and so on; slabstock foams, frequently used as carpet underlay or in furniture; and various other padding or cushioning uses. Foams having rigid, closed-cell structure are useful as insulation; simulated wood parts like speaker cabinets, picture frames, doors and the like; packaging foams; shock absorbing foams; and so on. Such foams should have good tensile strength, elongation, compressive strength, dimensional stability and other desired properties in order to perform well in these or other applications.

Spray elastomer polyurea systems are commonly recognised as coating material in various applications, such as protecting secondary containments and exposed structures such as bridges, steel tanks, piping, metal buildings, and practically any surface where corrosion exists or can be a problem.

Polyurea coatings are also used for renovating existing pipeline infrastructures such as potable water pipelines. Especially their fast setting and humidity insensitive curing properties make polyureas extremely suited for this application. The liquid coating composition is sprayed onto the internal surface of the pipeline from an apparatus which is moved through the pipeline, so as to form, at high cure rate, a monolithic flexible lining with high strength and ductility.

Chemical compositions and systems which come into contact with potable water should only contain raw materials or components which are on a positive list of the synoptic document (rating 0 to 4 is important for use in potable water applications): “Provisional list of monomers and additives notified to European Commission as substances which may be used in the manufacture of plastics intended to come into contact with foodstuffs” (SANCO D3/LR (2003)).

Polyurea elastomer systems are generally prepared by reacting an isocyanate with an amine in the presence of a chain extender. For internal pipecoating fast setting is required and hence a fast-curing chain extender needs to be used. Most of the fast-curing aromatic chain extenders such as diethyltoluene diamine (DETDA), one of the most widely used chain extenders, commercially available as Ethacure 100 or Lonzacure M80, are not amongst the approved chemicals for potable water applications.

4,4′-Methylene-bis(3-chloro-2,6-diethylaniline) (Lonzacure M-CDEA) is an approved chemical but provides systems that are too slow to be used for internal pipe coating.

Therefore it is an object of the present invention to provide a (hybrid) polyurea system that can be used for the interior lining of potable water pipelines, said polyurea system not containing any raw material or component which is not on the abovedescribed positive list (such as DETDA) and yet providing excellent and fast curing (gel times of a few seconds needed to produce a stable lining in a pipe).

It has been discovered that such polyurea systems or hybrid polyurea (mixed polyurea-polyurethane) systems can be made using polyaminoamides containing imidazoline groups as chain extender, preferably combined with 4,4′-methylene-bis(3-chloro-2,6-diethylaniline) or aceto amino trimethyl cyclohexane methanamine as additional chain extender.

Controlled cure is obtained (not too slow but also not too fast) with polyurea systems that are based solely on components that are on said positive list. Therefore said systems are extremely suited for the internal coating of potable water pipelines and storage tanks.

The present chain extender is a polyaminoamide containing imidazoline groups, which can be obtained by reacting a polyalkylene polyamine with an acid containing between 2 and 40 carbon atoms. Optionally said compound can be further reacted with an epoxide compound containing on average at least 1 epoxide group per molecule; however this will usually increase the viscosity of the chain extender.

The polyaminoamide containing imidazoline groups is prepared in a known manner by condensation of polyalkylene polyamines with fatty acids. Suitable polyalkylene polyamines include any linear or branched polyalkylene polyamine, preferably containing at least 3 amino groups, more preferably 4 to 5 amino groups such as dipropylene triamine, tripropylene tetramine, tetrapropylene pentamine. Polyethylene polyamines containing 5 or more amine hydrogen atoms are the preferred materials. Examples of such polyethylene polyamines include diethylene triamine (DETA), triethylene tetramine (TETA), tetraethylene pentamine (TEPA), pentaethylene hexamine (PEHA) and higher polyethylene polyamines. The acids containing 2 to 40 carbon atoms used in the condensation reaction can contain monomeric, dimeric, trimeric, saturated or unsaturated, linear or branched chain hydrocarbon residues. Preferred are fatty acids containing at least 8 carbon atoms. Particularly preferred are monomeric, unsaturated fatty acids containing at least 14 carbon atoms such as oleic acid, tall oil acid, linoleic acid, linolenic acid. Other suitable fatty acids having from 12 to 36 carbon atoms include lauric, palmitic, stearic, myristic and montanic acid. A preferred chain extender for use in the present invention is a reaction product of diethylene triamine and a C18-monomer fatty acid.

To prepare the present chain extender the acid component is added to the polyalkylene polyamine at a temperature of 60 to 100° C. The reaction mixture is heated to 180 to 260° C., sometimes up to 300° C. and the reaction water distilled off. In the first condensation step the amide is obtained; the second condensation step leads to the imidazoline. The yield of the second condensation step is determined by the amount of water that is distilled off and can be up to 90% of the polyaminoamide obtained in the first condensation step. Usually reaction mixtures containing at least 10 mole % polyaminoamide and up to 90 mole % of imidazoline-containing polyaminoamide are obtained. Preferably the reaction mixture contains the imidazoline-containing polyaminoamide in an amount of at least 40 mole %, preferably at least 60 mole %. The molar ratio polyalkylene polyamine/acid is preferably between 1:1 and 1:1.5.

Preferably the imidazoline content of the present chain extender is more than 60%, preferably more than 75%. A lower imidazoline content leads to higher viscosity products and to products which tend to crystalize.

Optionally the imidazoline-containing polyaminoamide can be further reacted with epoxide compounds. These epoxide compounds are generally available and usually contain more than one epoxide group per molecule, derived from mono- or polyfunctional phenols which can contain more than one ring, such as Bisphenol A and Bisphenol F diglycidylether. A list of further suitable epoxide compounds can be found in “Epoxidverbindungen und Epoxidharze”, A. M. Paquin, Springer Verlag Berlin, 1958. Such an adduct is obtained by heating the imidazoline-containing polyaminoamide to 60 to 100° C. and adding thereto the epoxide compound, which has been heated to about 50° C., in a period of about 60 minutes. To complete the reaction, stirring is continued for another 60 minutes. Preferably for one mole of imidazoline-containing polyaminoamide 0.01 to 0.5, preferably 0.05 to 0.2 epoxide equivalents of the epoxide compound are used.

Further details regarding the composition of this chain extender and its manufacture can be found in WO 03/031495, incorporated herein by reference.

A preferred chain extender for use in the present invention is an aminoimidazoline of diethylenetriamine and tall oil fatty acid of molecular weight about 357.

Such adducts of imidazoline-containing polyaminoamides with epoxide compounds are described in U.S. Pat. No. 5,541,338 as crosslinking compound for polyurethane, polyurethane/urea or polyurea elastomers made by reaction injection molding.

The present chain extender is generally used in an amount of between 2 and 35% by weight based on the total reactive system, preferably between 10 and 25%.

The polyurea system of the present invention contains the abovedescribed chain extender, a polyisocyanate and a polyfunctional isocyanate-reactive composition.

The first part of the polyurea system of the present invention comprises one or more polyisocyanates, which may be aliphatic or aromatic.

Suitable (cyclo)aliphatic isocyanates include hexamethylene diisocyanate (HDI), tetraalkyl xylene diisocyanate, cyclohexane diisocyanate, 1,12-dodecane diisocyanate, 1,4-tetramethylene diisocyanate, 1,3- and 1,4-cyclohexane diisocyanate, 1-isocyanato-3,3,5-trimethyl-5-isocyanatomethyl-cyclohexane (isophorone diisocyanate), 4,4′-, 2,2′- and 2,4′-dicyclohexyl-methane diisocyanate, as well as the corresponding isomer mixtures, and the like.

Aromatic isocyanates include, but are not necessarily limited to m-phenylene diisocyanate, p-phenylene diisocyanate, 4,4′- or 2,4′- or 2,2′-diphenylmethane diisocyanate (MDI), polymethylene polyphenylene diisocyanate (mixtures of MDI and oligomers thereof known in the art as “crude” or polymeric MDI having an isocyanate functionality of greater than 2), 2,4- and 2,6-toluene diisocyanate (TDI), dianisidine diisocyanate, bitolylene diisocyanate, naphthalene-1,4-diisocyanate, diphenylene 4,4′-diisocyanate and the like.

Suitable aliphatic/aromatic diisocyanates, include, but are not necessarily limited to xylylene-1,3-diisocyanate, bis(4-isocyanatophenyl)methane, bis(3-methyl-4-isocyanatophenyl)methane and 4,4′-diphenylpropane diisocyanate.

The aforestated isocyanates can be used alone or in combination.

In one embodiment of the invention, aromatic isocyanates are preferred as they provide faster reacting systems and have a lower toxicity level than the aliphatic isocyanates. A most preferred polyisocyanate is an isomer or isomer mixture of diphenylmethane diisocyanate (MDI), preferably containing from 30 to 95 wt % 4,4′-MDI and from 5 to 70 wt % 2,4′-MDI. As pure MDI is a solid and thus inconvenient to use, liquid MDI products resulting from uretonimine or carbodiimide modification are to be preferred.

Alternatively, quasi-prepolymers formed from the reaction of polyisocyanate (MDI, modified MDI and/or p-MDI) with polyhydric alcohols or polyamines (as described below) may be employed.

Examples of suitable polyhydric alcohols include polyether polyols, polyester polyols, polycarbonate polyols, polycaprolactone polyols, and other polyols. These polyols may be used either individually or in combinations of two or more.

Given as examples of the polyether polyols are polyethylene glycol, polypropylene glycol, polypropylene glycol-ethylene glycol copolymer, polytetramethylene glycol, polyhexamethylene glycol, polyheptamethylene glycol, polydecamethylene glycol, and polyether polyols obtained by ring-opening copolymerisation of alkylene oxides, such as ethylene oxide and/or propylene oxide, with isocyanate-reactive initiators of functionality 2 to 8.

Polyester diols obtained by reacting a polyhydric alcohol and a polybasic acid are given as examples of the polyester polyols. As examples of the polyhydric alcohol, ethylene glycol, polyethylene glycol, tetramethylene glycol, polytetramethylene glycol, 1,6-hexanediol, 3-methyl-1,5-pentanediol, 1,9-nonanediol, 2-methyl-1,8-octanediol, and the like can be given. As examples of the polybasic acid, phthalic acid, dimer acid, isophthalic acid, terephthalic acid, maleic acid, fumaric acid, adipic acid, sebacic acid, and the like can be given.

As examples of the polycarbonate polyols, polycarbonate of polytetrahydrofuran, poly(hexanediol carbonate), poly(nonanediol carbonate), poly(3-methyl-1,5-pentamethylene carbonate), and the like can be given.

Polycaprolactone diols obtained by reacting ε-caprolactone and a diol compound are given as examples of the polycaprolactone polyols having a melting point of 0° C. or higher.

Here, given as examples of the diol compound are ethylene glycol, polyethylene glycol, polypropylene glycol, tetramethylene glycol, polytetramethylene glycol, 1,2-polybutylene glycol, 1,6-hexanediol, neopentyl glycol, 1,4-cyclohexanedimethanol, 1,4-butanediol, and the like.

As examples of other polyols, ethylene glycol, propanediols, 1,4-butanediol, 1,5-pentanediol, 1,6-hexanediol, cyclohexanedimethanol, polyoxyethylene bisphenol A ether, polyoxypropylene bisphenol A ether, polyoxyethylene bisphenol F ether, polyoxypropylene bisphenol F ether, and the like can be given.

The relative amount of polyisocyanate to polyol or polyamine for quasi-prepolymer production is at least a stoichiometric excess of polyisocyanate to polyol or polyamine. Generally more than 1, preferably from about 1.05 to about 25, and most preferably from about 10 to about 25 equivalent moles of polyisocyanate are used per mole of polyol or polyamine.

The preferred aromatic polyisocyanates typically have an isocyanate content of 5 to 35%, preferably 10 to 25%, most preferably 15 to 20%.

A particularly preferred polyisocyanate for use in the present polyurea system is a prepolymer of NCO value 16 to 25%, preferably 16 to 20% obtained from MDI, optionally uretonimine-modified and polypropyleneglycol (preferred MW 2000).

The second part of the polyurea system of the present invention comprises a polyfunctional isocyanate-reactive composition, preferably comprising one or more polyamines optionally blended with one or more polyhydric alcohols. In the latter case a hybrid polyurea system is obtained containing some polyurethane groups. The polyhydric alcohol can be any of the polyhydric alcohols described above in relation to the quasi-prepolymer composition.

A preferred polyhydric compound to be used in said second part is 1,4-butanediol or monoethyleneglycol. Said polyhydric alcohol, if used, is used in amount inferior to the amount of polyamine. Generally the amount of polyhydric alcohol is less than 50 wt % based on the total polyfunctional isocyanate-reactive compounds, preferably between 5 and 15 wt %. Advantages of adding such a polyhydric alcohol include controlled cure profile and reliable mixing.

The polyamine is preferably a polyoxyalkylene polyamine. The polyoxyalkylene polyamine can be a primary and/or secondary amine-terminated polyether polyol typically having a weight average molecular weight of more than about 100 and preferably from about 200 to about 5000; a functionality of from 2 to 6, and preferably from 2 to 3; and an amine equivalent weight of from about 750 to about 4000. Polyoxyalkylene polyamines include compounds shown in formula below

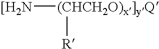

The variables in this formula have the following meanings. Q′ is the polyvalent residue of an active hydrogen-containing compound used as an initiator. The valence of Q′ is given by y′, where y′ is at least 2, preferably 2 to 8, and most preferably 2 to 3. Each R′ is independently hydrogen or lower alkyl, such as methyl or ethyl. The R′ groups are preferably hydrogen and/or methyl, including their mixtures. The average number of oxyalkylene repeating units per amine, given by x′, is at least 1, preferably from about 1 to about 40, and most preferably from about 1 to about 10.

Typical initiators include, among others, one or more of the following: polyhydroxy compounds, including diols like ethylene glycol, propylene glycol, 1,2- or 1,4-butanediols, and triols like trimethylolpropane and glycerine. Preferred initiators include ethylene glycol, propylene glycol, trimethylolpropane and glycerine. Typical oxyalkylene repeating units include oxyethylene, oxypropylene, oxybutylene, and so on, including mixtures thereof. When two or more oxyalkylenes are used, they may be present in any form such as randomly or in blocks. Preferred polyoxyalkylene polyamines include JEFFAMINE polyoxyalkylene polyamines commercially available from Huntsman, such as diamines D-230, D-400, D-2000, D-4000, SD-231, SD-401, XTJ-576 and triamines T-403, T-3000, T-5000, ST-404. In case the present polyurea system is used for potable water pipeline internal coating the presence of JEFFAMINE T5000, T3000 and T403 is to be avoided.

In the practice of this invention, a single polyamine may be used but also mixtures of high molecular weight polyoxyalkylene polyamines, such as mixtures of di- and trifunctional materials and/or different molecular weight or different chemical composition materials, may be used.

Apart of the abovedescribed imidazoline-containing polyaminoamide chain extender the present polyurea system may also contain conventional amine-terminated chain extenders for polyurea systems as known and described in the prior art.

Suitable chain extenders include, but are not necessarily limited to, those aliphatic and cycloaliphatic diamine chain extenders mentioned in U.S. Pat. Nos. 5,162,388 and 5,480,955, incorporated herein by reference. Aromatic diamine chain extenders may also be useful, such as those described in U.S. Pat. No. 5,317,076, incorporated herein by reference. In one embodiment of the invention, aromatic chain extenders are preferred.

Examples of suitable additional chain extenders include 1-methyl-3,5-diethyl-2,4- or 2,6-diaminobenzene (also called diethyltoluene diamine or DETDA); 1,3,5-triethyl-2,6-diaminobenzene; 3,5,3′,5′-tetraethyl-4,4′-diaminodiphenylmethane; di(methylthio)-toluene diamines including 3,5-di(methylthio)-2,4 and 2,6-toluene diamine; N,N′-bis(t-butyl)ethylene diamine; 4,4′-methylenebis(2-isopropyl-6-methylaniline); 4,4′-methylenebis(2,6-diisopropylaniline; isophorone diamine; guanamines as described in WO 2004/090009 in particular 2,4-diamino-6-nonyl-1,3,5-triazine (available from Degussa), Clearlink 1000 (available from UOP); Polyclear 135 (commercially available from BASF); 4,4′-methylene-bis(3-chloro-2,6-diethylaniline) (commercially available as LONZACURE M-CDEA)); aceto amino trimethyl cyclohexane methanamine (commercially available as JEFFLINK 754). Especially the latter two are preferred as additional chain extender; in case the polyurea system is used as internal coating for potable water pipelines LONZACURE M-CDEA is particularly preferred.

In case LONZACURE M-CDEA is used as additional chain extender it is preferred to add 1,4-butanediol to improve cure; in case JEFFLINK 754 is added monoethyleneglycol is preferably added for the same purpose.

The total amount of chain extender in the total polyurea elastomer system of this invention may range from about 7 to about 30 wt %, preferably from about 10 to about 25 wt %, more preferably from about 10 to about 17 wt %.

Advantageously, the polyisocyanate and isocyanate-reactive components including the chain extender(s) react to form the present polyurea elastomer system without the aid of a catalyst. However, if desired, a catalyst can be used.

Catalysts such as tertiary amines or an organic tin compound may suitably be a stannous or stannic compound, such as a stannous salt of a carboxylic acid, a trialkyltin oxide, a dialkyltin dihalide, a dialkyltin oxide, etc., wherein the organic groups of the organic portion of the tin compound are hydrocarbon groups containing from 1 to 8 carbon atoms. For example, dibutyltin dilaurate, dibutyltin diacetate, diethyltin diacetate, dihexyltin diacetate, di-2-ethylhexyltin oxide, dioctyltin dioxide, stannous octoate, stannous oleate, etc, or a mixture thereof, may be used. Tertiary amine catalysts include trialkylamines (e.g. trimethylamine, triethylamine); heterocyclic amines such as N-alkylmorpholines (e.g. N-methylmorpholine, N-ethylmorpholine, etc.), 2,2′-dimorpholinodiethyl ether, 1,4-dimethylpiperazine, etc.; and aliphatic polyamines such as N,N,N′,N′-tetramethyl-1,3-butanediamine, dimethyldiaminodiethylether, triethylenediamine.

In one embodiment of this invention (but not in case the polyurea system is used as internal coating for potable water pipelines) the polyurea elastomer system of this invention may also include an organic alkylene carbonate, as defined in U.S. Pat. No. 5,442,034, incorporated by reference herein. As noted therein, the alkylene carbonates are preferably chosen from the group of ethylene carbonate, propylene carbonate, butylene carbonate and dimethyl carbonate. The use of the alkylene carbonate reduces the viscosity of the system. he alkylene carbonate also allows slower effective reactivities in spray polyurea elastomer systems, improved properties and surface characteristics (flowability) and improved adhesion to the surfaces on which the elastomer is sprayed. It can also act as a compatibilizer between the two components to improve the mixing of components and homogeneity of the system.

Further suitable additives include functional alkoxy silanes, as described in U.S. Pat. No. 5,731,397, to improve adhesion.

Other conventional formulation ingredients may be employed in the polyurea elastomer systems of this invention, such as, for example, foam stabilisers, also known as silicone oils or emulsifiers. The foam stabilisers may be an organic silane or siloxane like polysiloxane-polyoxyalkylene block copolymers. Pigments or coloring agents, for example titanium dioxide, may be incorporated in the elastomer system to impart color properties to the elastomer. Typically, such pigments are added with the amine resin. Reinforcing material, if desired, useful in the practice of the invention are known to those skilled in the art. For example, chopped or milled glass fibers, chopped or milled carbon fibers and/or mineral fibers are useful.

Organic and inorganic fillers can be added to increase the bending modulus and to improve the processing of the system. These fillers can be added to the polyisocyanate composition and/or to the isocyanate-reactive composition. Amount of fillers is generally in the range 0 to 40 wt % based on isocyanate-reactive composition. A particularly preferred filler is talc.

The relative amount of polyisocyanate to polyoxyalkylene polyamine and chain extender(s) is any amount sufficient to make polyurea elastomer. Typically, from about 0.7 to about 1.6, preferably from about 0.8 to about 1.3, and most preferably from about 1.05 to about 1.25 moles of isocyanate are provided per mole of amine. Typically, from about 30 to about 80, preferably from about 40 to about 60, weight percent chain extender is provided based on the amount of polyoxyalkylene polyamine.

The weight percentage, mole percentage or volume of starting components will vary depending upon the equipment utilized, the starting components activities and the desired product's characteristics. General formulations envisioned of component A (polyisocyanate) and component B (polyamine/polyol and chain extender(s)) useful to produce the polyurea elastomeric system of the instant invention comprise from about 30-70 wt % component A to about 70-30 wt % component B, more preferably from about 40-60% component A to about 60-40% component B, and most preferably a 50-50% mixture by weight of component A and component B.

The polyisocyanate, polyoxyalkylene polyamine and chain extender(s), along with any other optional ingredients, are reacted under any effective, including known, conditions for reacting polyamines with polyisocyanates. Typically, the temperature during the reaction may range from about 0 to about 90° C., preferably from about 40 to about 90° C., and most preferably from about 60 to about 80° C. The components can be combined under ambient or higher pressures of up to 3000, preferably from about 1500 to about 3000, and most preferably from about 2000 to about 2500 psig.

When used in spray applications, the components can be impingement mixed directly using high pressure spray equipment. In particular, first and second pressurized streams of components (A) and (B), respectively, are delivered from two separate chambers of a proportioner and impacted or impinged upon each other at high velocity for intimate mixing of the two components producing the elastomer which is then delivered onto or into desired substrate using the spray gun or RIM equipment. The volumetric ratio of components (A) to (B) may be any suitable amount, typically from about 3:7 to 7:3. The components are typically applied at a rate of at least 0.5, and preferably from about 1 to about 30, and most preferably at about 20 pounds per minute.

The polyurea elastomer may, optionally, undergo post curing by heating, such as following established procedures. Post curing is typically employed to improve elastomeric properties, such as heat sag.

The obtained polyurea may have a small amount of urethane or other bonds formed from isocyanate reaction with hydroxyl or other active hydrogen groups in the reaction components.

The polyurea of the present invention is useful for spraying, rolling, caulking or trowelable type uses. Spraying of the instant invention would be accomplished by a high or low pressure spray gun or similar instrumentalities. Rolling of the instant invention would be accomplished by any suitable roller such as an equipment roller or a manual roller. Caulking of the instant invention could be accomplished by utilising caulking guns, caulking machines or the like. A trowel is envisoned when utilizing the instant invention in troweable type uses.

Polyureas of the present invention are useful as coatings, joint fillers, in erosion prevention, abrasion prevention, encapsulation, corrosion protection, chemical protection, structural repair and other similar processes.

Specific uses wherein the instant invention has advantages over existing polyureas would be in the internal coating of potable water pipelines where, at high cure rate, a monolithic lining is formed which exhibits high strength and flexibility and a high level of adhesion to the existing pipe wall. The imidazoline polyaminoamide chain extender can replace DEDTA, which is not an approved chemical for such applications, and still provide a fast curing system. Further the quality and physical properties of the present polyurea coatings are equivalent to polyurea coatings based on DEDTA.

In carrying out such internal pipeline coating, the first and second parts of the system are fed independently, e.g. by flexible hoses, to a spraying apparatus, known per se, capable of being propelled through an existing pipeline to be renovated. The apparatus preferably heats the two parts of the system prior to application to the pipeline interior and mixes the two parts immediately before applying the mixture to the interior surface of the pipeline. The hoses between the machine and spray head are usually heated to maintain a set temperature needed for good mixing, resulting in a lower viscosity for the components thus better mixing by impingement and superior cured material properties. The mixture of the two parts cures on the interior surface of the pipeline to form a flexible impervious coating.

Spray equipment especially adapted for said application is commercially available from TWIN INPRES.

The present polyurea system can be used to coat the internal surface of drinking water pipelines, storage tanks, reservoirs and irrigation networks (e.g. to renovate them or to repair them with a structural liner or to protect provisonally) but also more and more waste water networks are being internally coated with “approved” systems containing only raw materials or components that are on the positive list to prevent contamination of the purification installation. The present polyurea system can also be used as a lining for new piping e.g. in a production unit before they are installed underground.

The various aspects of this invention are illustrated, but not limited by the following examples.

In these examples the following ingredients were used:
ISO 1: a prepolymerised MDI of NCO value 19.3% based on di-MDI and p-MDI and polypropyleneglycol
ISO 2: a prepolymerised MDI of NCO value 15% based on uretonimine-modified di-MDI and polypropylene glycol
ISO 3: a prepolymerised MDI of NCO value 18% based on uretonimine-modified di-MDI and polypropylene glycol
ISO 4: a prepolymerised MDI of NCO value 18.3% based on uretonimine-modified di-MDI and polypropylene glycol.
JEFFAMINE D2000: polyalkylene polyamine of average MW 2000 available from Huntsman
JEFFAMINE T5000: polyalkylene polyamine of average MW 5000 available from Huntsman
DETDA: available from Albemarle (as Ethacure 100) or from Lonza (as Lonzacure M80)
Lonzacure M-CDEA: available from Lonza
Jefflink 754: available from Huntsman
BDO: 1,4-butanediol
MEG: monoethylene glycol
TK2971: an aminoimidazoline of diethylenetriamine and tall oil fatty acid of MW 357
Talc: filler

### EXAMPLE 1

The ingredients are mixed at about 80° C. in the amounts as indicated in the table below (pbw) and then sprayed with an impingement mixing gun onto concrete, steel or brick walls.

The reactivity of the system (gel time) was checked.

Microscopic evaluation of the obtained coating was done to determine the presence of blisters or bubbles.

The general quality of the coating was checked visually.

Film properties such as tensile strength, elongation, tear strength and hardness were measured.

The results are presented in the table below.

These results show that polyurea systems according to the invention (#4-11) provide coatings of good quality with an acceptable cure profile and film properties.

TABLE 1

| System # | 1 | 2 | 3 | 4 | 5 | 6 | 7 | 8 | 9 | 10 | 11 |
|---|---|---|---|---|---|---|---|---|---|---|---|
| ISO 1 | | 100 | | 57.1 | | | 95.3 | | | | |
| ISO 2 | 100 | | 67.1 | | 75.4 | 125.9 | | | | | |
| ISO 3 | | | | | | | | 100 | | 125 | 115 |
| ISO 4 | | | | | | | | | 100 | | |
| D2000 | 61.6 | 62.4 | 70 | 59 | 59 | 55 | 55 | 55 | 64.7 | 64.7 | 51.7 |
| T5000 | 10.3 | | | | | | | | | | |
| DETDA | 28.1 | 37.6 | | | | | | | | | |
| M-CDEA | | | 30 | 29 | 29 | 18 | 18 | 18 | | | |
| Jefflink 754 | | | | | | | | | 7.3 | 7.3 | 5.9 |
| BDO | | | | | | 10 | 10 | 10 | 12 | | |
| MEG | | | | | | | | | | 12 | 9.6 |
| TK2971 | | | | 12 | 12 | 17 | 17 | 17 | 16 | 16 | 12.8 |
| Talc | | | | | | | | | | | 20 |
| Positive List | NO | NO | YES | NO | YES | YES | NO | YES | NO | NO | NO |
| Blistering | NO | NO | NO | NO | NO | NO | NO | NO | NO | NO | NO |
| Quality | OK | Poor | OK | OK | OK | OK | OK | OK | OK | OK | OK |
| Gel time (sec) | 3 | <1 | >15 | 3 | 10 | 6 | 1 | 3 | 2 | 2 | 2 |
| Tensile | 20.6 | | | 11 | 9 | 13 | 14 | 14 | 12 | | |
| strength (MPa) | | | | | | | | | | | |
| Elongation (%) | 400 | | | 220 | 320 | 280 | 120 | 250 | 350 | | |
| Trouser Tear | 32 | | | 23 | 25 | 28 | 21 | 25 | 20 | | |
| Strength (N/m) | | | | | | | | | | | |
| Hardness | 46 | | | 47 | 39 | 43 | 48 | 45 | 36 | | |
| Shore D | | | | | | | | | | | |

1. Use of a polyaminoamide containing imidazoline groups as a chain extender in (hybrid) polyurea systems.

2. Use according to claim 1 wherein the polyaminoamide containing imidazoline groups is obtained by reacting a polyethylene polyamine containing 5 or more amine hydrogens with an acid containing between 2 and 40 carbon atoms.

3. Use according to claim 2 wherein diethylenetriamine is used as the polyethylene polyamine and tall oil fatty acid as the acid.

4. Use according to claim 1 wherein the imidazoline content of the polyaminoamide is more than 60%.

5. Use according to claim 1 wherein an adduct of said polyaminoamide and an epoxide compound containing on average at least 1 epoxide group per molecule is used as said chain extender.

6. A polyurea system comprising a) a polyisocyanate composition, and b) a polyfunctional isocyanate-reactive composition containing a chain extender, said chain extender comprising a polyaminoamide containing imidazoline groups.

7. The polyurea system according to claim 6 wherein the polyisocyanate is an aromatic polyisocyanate having an NCO value of between 5 and 35 wt %.

8. The polyurea system according to claim 6 wherein the polyfunctional isocyanate-reactive composition comprises one or more polyoxyalkylene polyamines and optionally one or more polyhydric alcohol compounds.

9. The polyurea system according to claim 6 wherein the chain extender is present in an amount of 5 to 25 wt % based on the total isocyanate-reactive composition.

10. The polyurea system according to claim 6 including 4,4′-methylene-bis(3-chloro-2,6-diethylaniline) as an additional chain extender.

11. The polyurea system according to claim 10 including 1,4-butanediol as a polyhydric alcohol.

12. The polyurea system according to claim 6 including aceto amino trimethyl cyclohexane methanamine as an additional chain extender.

13. The polyurea system according to claim 12 including monoethyleneglycol as a polyhydric alcohol.

14. The polyurea system according to claim 6 that is adapted to enable the spraying of an internal surface of a pipeline or storage tank to coat said internal surface.

15. A method for forming a coating on a surface, comprising the steps of: a) providing a liquid, two-part polyurea system, said liquid, two-part polyurea system including as a first part a polyisocyanate composition, and as a second part a polyfunctional isocyanate-reactive composition and a chain extender, said chain extender comprising a polyaminoamide containing an imidazoline group, b) mixing together the first part and the second part to form a mixture, and c) applying the mixture as a coating to said surface.

16. The method of claim 15 wherein applying the mixture as a coating includes applying the mixture to the internal surface of a drinking water pipeline or storage tank to coat said internal surface.
